(19) United States
(12) Patent Application Publication
(10) Pub. No.: US 2004/0046151 A1
(43) Pub. Date: Mar. 11, 2004

(54) Formol-free crosslinked core-shell latex for textile

(76) Inventors: Leo Mario Saija, Bagnolo in Piano (IT); Mario Lugli, Fabbrico (IT)

Correspondence Address: WHYTE HIRSCHBOECK DUDEK S C, 555 EAST WELLS STREET, SUITE 1900, MILWAUKEE, WI, 53202, US

(21) Appl. No.: 10/432,084

(22) PCT Filed: Nov. 19, 2001
(86) PCT No.: PCT/EP01/13531

(30) Foreign Application Priority Data
Nov. 21, 2000 (IT) M12000A002498

(51) Int. Cl. H01C 1/00

(52) U.S. Cl. 252/500

(57) ABSTRACT

Aqueous dispersions of acrylic polymers which do not release formaldehyde, comprising the following components: a) from 25% to 95% by weight of one or more polymerizable acrylic monomers whose corresponding homopolymer has a Tg of less than 0 ° C.; b) from 4% to 70% by weight of one or more polymerizable acrylic monomers whose corresponding homopolymer has a Tg of greater than 0 ° C.; c) from 0.05% to 4% by weight of one or more monomers containing at least two ethylenic unsaturations; d) from 0.2% to 5% by weight of a vinylsilane having the formula: CH₂═CR—Si(OR′)ₙRₘe) from 0.2% to 10% by weight of an ethylenically unsaturated monomer containing one or more acid groups; the sum of the components a) +b) +c) +d) +e) being 100%.

The present invention relates to aqueous dispersions of polymers for treating glass fibres or textile fibres, optionally in the form of wovens or nonwovens.

In particular, the invention relates to aqueous dispersions of acrylic copolymers which, when applied to fibres, impart and maintain an optimum combination of mechanical properties such as tensile strength, elongation at break, hand (softness), elasticity, dry and wet abrasion resistance, and also high resistance to water and solvents (resistance to washing) and good adhesion to the substrate.

It is known that the use of water-based polymer dispersions in the textile field has widely replaced that of solvent-based products, due to their reduced environmental impact.

The polymer dispersion may act as binder and/or adhesive agent, for instance in applications such as flocking, coating, laminating, and nonwovens impregnation ; alternatively, it may act as a binder/dispersing agent, for instance in textile pigment printing, or, finally, it may be used as a dressing or size.

For most of the above mentioned applications, it is necessary for the polymer phase to be able to interact with the fibres, thus giving the manufactured product sufficient mechanical strength and chemical resistance, in particular during the dry-cleaning and washing operations and/or in spot-removing operations. The expression “mechanical strength” means the combination of the mechanical properties mentioned above. The expression “chemical resistance” means the resistance to solvents, water, alcoholic solutions, etc.

The aqueous polymer dispersions most commonly used in this field are those functionalized with crosslinking monomers capable of giving, upon drying at high temperature, covalent bonds between the polymeric chains and between the polymer and the fibre. In this way, it is possible to form crosslinked structures that are resistant to the action of external agents.

The functional monomers that are most effective for this application are methylol derivatives of (meth)acrylamide, for example N-methylol(meth)acrylamide (N(M)MA). These monomers are characterized by an ethylenic double bond which allows them to undergo free-radical polymerization, and by an —NHCH₂OH group which allows crosslinking by means of a condensation reaction with other functional groups at high temperature, in general above 100° C. In this way, covalent bonds are formed between chains or between a polymer chain and the support. The main drawback of this crosslinking system is that, during the condensation reaction, which takes place as stated at high temperature, formaldehyde is released. Formaldehyde is a colourless gas with an irritant odour, which is water-soluble and which, since 1987, has been classified by the World Health Organization as a potential human carcinogenic agent. For this reason, very low limits on the residual amounts of formaldehyde have been set. Thus, the use of polymer dispersions which produce formaldehyde has become problematic in the case of treating nonwoven materials used in the medical field, in which a maximum HCHO content of less than 30 ppm is required, in paediatrics (HCHO content <20 ppm) or in the clothing field (HCHO content <100 ppm).

Specifically, with acrylic dispersions functionalized with NMA it is difficult to achieve residual HCHO values that are within the set limits, without prejudicing the mechanical strength and chemical resistance of the treated material.

Consequently, the production process would require additional treatments to reduce the residual amount of HCHO such that it is below the limit values mentioned above, with a penalizing effect on the costs. However, these treatments are rarely effective. To this end, it should be added that the working environments in which these treatments are carried out must be provided with adequate safety standards.

For these reasons, it is necessary in this sector to use other products, such that during the production and use cycle, no formaldehyde or other toxic substances are produced.

U.S. Pat. No. 5,362,798 describes aqueous dispersions based on SBR, styrene-butadiene elastomeric copolymer, which also contain in the chain functional monomers, such as, for example, acetoacetoxyethyl methacrylate, to allow self-crosslinking. Other patents such as, for example, U.S. Pat. No. 5,198,492 describe an SBR resin functionalized with an acrylic monomer containing —CONH— groups, for example methacrylamide glycolate methyl ether. These dispersions produce low levels of HCHO. However, aqueous dispersions based on SBR have the drawback of being relatively unstable on ageing and of causing yellowing of the treated textile fibres.

It is also known practice to use aqueous dispersions that are self-crosslinking at low temperature. For example, patent U.S. Pat. No. 3,706,697 describes acrylic emulsions obtained by polymerization of an acrylic monomer, an acryloyloxyalkylsilane and another copolymerizable monomer chosen from vinyl acetate, styrene, acrylonitrile, acrylamide, etc. The said patent states that the silane monomer may be added even after an amount between 15% and 80% of the acrylic monomer and of the other copolymerizable monomer has been polymerized. Optionally, during the polymerization, polyfunctional monomers may be added, such as, for example, trimethylolpropane triacrylate. The dispersions obtained are used to increase the wet strength of paper. In the examples of the said patent, it is shown that the use of acryloyloxyalkylsilane, in particular γ-methacryloyloxypropyltrimethoxysilane, improves the wet mechanical properties (wet tensile strength) both in water and in solvent. The description also states that vinylsilanes cannot be used on account of their low polymerization reactivity towards acrylic monomers. Specifically, according to the prior art, this type of silane has a rate of hydrolysis which is greater than the rate of polymerization, with a consequent risk of premature cross-linking in the wet state and formation of coagula. Thus, the said patent teaches that to obtain self-crosslinking polymers, the acryloyloxyalkylsilanes described above are required. The application examples relate to paper and no application relating to glass fibres or textile fibres is given. In addition, in the polymerization process used, a buffer agent (sodium phosphate) is mandatorily used to keep the polymerization pH at about 7.

U.S. Pat. No. 4,959,249 describes self-crosslinking vinyl dispersions that are free of or produce only low levels of formaldehyde, which are applied to textile fibres, giving good mechanical properties that are maintained even after treatment with water and solvents. The essential components of the dispersions are vinyl esters and vinyltrialkoxysilanes or alkylvinyldialkoxysilanes, plus other optional components. Dispersions of acrylic monomers are not described. In the said patent, it is also indicated that acrylic dispersions of the prior art that are free of formaldehyde have insufficient mechanical properties or poor resistance to solvents or water. Also, in certain circumstances, the vinyl dispersions may, after application, give rise to yellowing of the finished manufactured products.

It was thus found to be necessary to have available aqueous dispersions of self-crosslinking polymers for treating glass fibres and textile fibres, which, after application, will not yellow and will not produce residual amounts of formaldehyde, while maintaining an optimum combination of mechanical properties such as tensile strength, elongation at break, hand (softness), elasticity, dry and wet abrasion resistance, and in particular high resistance to water and solvents (washing or dry-cleaning) that are comparable with those imparted by the use of systems based on N-methylol(meth)acrylamide and derivatives thereof.

The Applicant has found, surprisingly and unexpectedly, aqueous polymer dispersions as described above that are capable of giving the combination of properties mentioned above.

Thus, one subject of the present invention is aqueous dispersions of acrylic polymers which do not release formaldehyde during the application stage, comprising the following components:

a) from 25% to 95% by weight of one or more polymerizable acrylic monomers whose corresponding homopolymer has a glass transition temperature (Tg) less than 0° C. and preferably less than −20° C.;

b) from 4% to 70% by weight of one or more polymerizable acrylic monomers whose corresponding homopolymer has a Tg greater than 0° C. and preferably greater than 40° C.;

c) from 0.05% to 4% by weight and preferably from 0.05% to 2% by weight of one or more monomers containing at least two ethylenic unsaturations;

d) from 0.2% to 5% and preferably 0.5-3% by weight of a vinylsilane having the formula:

CH₂═CR—Si(OR′)ₙRₘ

in which:

n is an integer equal to 2 or 3;

m is an integer equal to 0 or 1,

R=H or CH₃,

R′=C₁-C₁₀ and preferably C₃-C₅ alkyl group, which is linear or branched if possible;

e) from 0.2% to 10% by weight of an ethylenically unsaturated monomer containing one or more acid groups, preferably carboxylic acid groups, or corresponding salts and/or corresponding anhydrides;

the sum of the components a) +b) +c) +d) +e) being 100%, the said aqueous dispersions being obtainable by means of a free-radical polymerization process, the polymerization being carried out in the presence of initiator systems or redox pairs in which the reducing agent does not release formaldehyde the polymer dispersion at the end of the polymerization being subjected to a treatment to reduce the free monomer content with redox pairs in which the reducing agent does not release formaldehyde.

The initiator systems used in the polymerization phase (pre-emulsion feed) are those for the free-radical polymerization of monomers in aqueous emulsion. Preferred systems which may be mentioned are organic hydroperoxides in aqueous solution or salts thereof and peroxydisulphuric acid salts. Mention may be made of tert-butyl hydroperoxide and ammonium persulphate.

The reducing agents of the redox pairs which do not release formaldehyde are, for example, ammonium or alkali metal hydrogen sulphites, for example sodium metabisulphite, ascorbic acid, a monofunctional aldehyde with a number of carbon atoms greater than or equal to 4 and containing at least one salifiable hydrogen, which is organic or inorganic, or salts thereof, the aldehyde reducing agent or salts thereof being water-soluble to at least 5% by weight and preferably to at least 10% by weight. Another reducing agent which may be used is a sulphinic acid of formula MO—S(O)—C(R¹R²R³), in which M is hydrogen, ammonium, a monovalent metal ion or a divalent ion chosen from groups Ia, IIa, IIb, IVa and VIIIb; R¹ is OH or NR⁴R⁵ in which R⁴ and R⁵, independently of each other, are H or C₁-C₆ alkyl; R² is H, alkyl, alkenyl, cycloalkyl or aryl, in which the aromatic ring may optionally contain substituents in position 1, 2 or 3, which are chosen, independently of each other, from C₁-C₆ alkyl, OH, C₁-C₆ alkoxy, halogen, CF₃; R³ is H, COOM, SO₃M, COR⁴, CONR⁴R⁵ or COOR⁴, in which M, R⁴ and R⁵ have the meanings given above or, when R² is aryl, it is as defined above. These reducing agents and the method for preparing them are described in patent application DE 197 43 759.

Reducing agents which must not be used are sodium formaldehyde sulphoxylate or similar products since they release formaldehyde.

The oxidizing agents of the redox pair which may be mentioned are the initiators- mentioned above or hydrogen peroxide and peroxydisulphuric acid salts.

Preferably, in the dispersions of the invention, the components d) and optionally e) are added after components a) +b) +c) have been polymerized, preferably to about one half by weight of the total amount of a) +b) +c). By working in this way, the components d) and optionally e) are substantially located in the outer layer of the particles. It has been found that phenomena of interaction or crosslinking with the other polymer particles and with the fibres, leading to the optimum combination of properties as described above, may be promoted in this way. Depending on the particle size, the addition of the monomers d) and e) may also take place after two-thirds by weight of the total amount of a) +b) +c) have been polymerized. A person skilled in the art is capable of determining the right time for addition of the monomers d) and e) such that these comonomers are preferentially located on the outside of the polymer particles. It has been found by the Applicant that an optimum combination of properties as mentioned above is obtained when the component e) is polymerized together with a) +b) +c), preferably for at least one-half and more preferably for at least two-thirds by weight of the total amount of a) +b) +c) +e); alternatively, the component e) is added together with the component d), after one-half of a) +b) +c) have been polymerized, giving results that are substantially identical to those of the above procedure.

Components which may be used as component a) are monomers of (meth)acrylic type containing from 4 to 20 carbon atoms and preferably from 5 to 15 carbon atoms, and mention may be made, for example, of acrylic or methacrylic esters, for example ethyl acrylate, butyl acrylate and 2-ethylhexyl (meth)acrylate.

Components which may be used as component b) are monomers of (meth)acrylic type containing from 3 to 20 carbon atoms and preferably from 3 to 10 carbon atoms. Mention may be made of acrylic or methacrylic esters, preferably methyl methacrylate, ethyl methacrylate; acrylamide and acrylonitrile. Styrene or derivatives thereof may optionally be used as a mixture with the component b), in an amount generally of 5-70% by weight relative to the total weight of b).

Components which may be used as component c) are monomers containing at least two ethylenic unsaturations of acrylic, vinylic or allylic type, such as, for example, allyl methacrylate, ethylene glycol di(meth)acrylate (EGD(M)A); monomers containing more than two ethylenic unsaturations as defined above are those that are preferred as component c), for example trimethylolpropane tri(meth)acrylate (TMPTA).

Components d) which may be mentioned are vinyltriisopropoxysilane and vinyltrimethoxysilane.

Components e) which may be mentioned are (meth)acrylic acid, itaconic acid, acrylamidodimethylpropanesulphonic acid, styrenesulphonic acid, maleic acid and fumaric acid, or the anhydrides or salts of the said acids. An ethylenically unsaturated comonomer with more than one acid group of carboxylic type is preferably used.

The dispersions that are preferred in the invention contain from 60% to 90% by weight of component a), from 5% to 30% by weight of component b), from 0.5% to 1.5% by weight of component c), from 0.5% to 4% by weight of component d) and from 0.5% to 2.5% by weight of component e), the sum of the components being 100%.

The dispersions of the present invention are obtained by means of a free-radical polymerization process of semi-continuous type, in aqueous emulsion, in which a portion of a pre-emulsion of monomers, prepared beforehand, is introduced into the reactor to initiate the polymerization, while the remaining portion of the pre-emulsion is fed in continuously or batchwise, immediately after the exothermic peak. In general, the exothermic peak takes place about 5-20 minutes after introducing the initiator systems.

One process for obtaining the dispersions of the invention comprises the preparation of a pre-emulsion consisting of components a) +b) +c) and optionally e), and 2-10% by weight of this pre-emulsion is fed into the polymerization reactor to initiate the reaction; at the exothermic peak, the remaining portion of pre-emulsion of the components a) +b) +c) and optionally e) is fed in at a constant feed rate over a time of 1 to 5 hours, up to about one-half and preferably two-thirds by weight, of the total amount of monomers; the further residual portion of pre-emulsion a) +b) +c) and optionally e) is then fed in, enriched with the component d), and optionally e) when this component has not been added together with a) +b) +c), in the concentrations defined above, over a period from about 30 minutes to 2.5 hours. The amount of e), when it is used together with a) +b) +c), ranges from 0% to 100% by weight relative to the total amount of e). The feed times are generally such that the temperature in the polymerization reactor is kept constant.

Another process for obtaining the dispersions of the invention consists, after having initiated the reaction with a pre-emulsion consisting of the components a) +b) +c) and optionally e), in sequentially polymerizing first a pre-emulsion a) +b) +c) and optionally e), and then a pre-emulsion a) +b) +d) +e), the pre-emulsions preferably having the same ratio of the components a)/b); the first pre-emulsion a) +b) +c) and optionally e) being in an amount by weight equal to one-half and preferably two-thirds of the total amount of monomers, and the second pre-emulsion a) +b) +d) +e) being in an amount by weight equal to about one-half and preferably one-third of the total amount of monomers.

The amount of e) in the first pre-emulsion ranges from 0% to 75% by weight of the total amount of e) and in the second pre-emulsion it ranges from 25% to 100% by weight of the total amount of e).

The pre-emulsions mentioned above are prepared by known techniques using conventional or polymerizable surfactants. For example, mention may be made of anionic surfactants such as alkanesulphonates; nonionic surfactants such as ethoxylated alkylphenols, for example nonylphenol ethoxylated with 20 mol of ethylene oxide, or ethoxylated fatty alcohols, for example a C₁₂-C₁₄ fatty alcohol ethoxylated with 30 mol of ethylene oxide.

Preferably, the initiator systems and the surfactants, when they are used in the form of salts, are used in the form of ammonium salts.

The polymer dispersion of the invention may be post-stabilized, if necessary, with the surfactants mentioned for the preparation of the pre-emulsions, preferably nonionic surfactants.

The polymerization temperatures used are preferably in the range from 30° C. to 80° C.

At the end of the polymerization, the polymer dispersions are subjected to a treatment to reduce the residual monomer content with redox pairs. Redox pairs which may be used are those mentioned above.

The aqueous dispersions of the present invention in the form of latices are characterized in physicochemical terms (see the examples); they are then dried to obtain polymer films for physicomechanical characterization (see the examples).

As stated, the dispersions of the invention may be used in unmodified form or for the preparation of formulations for use in treating textile fibres or glass fibres.

It has been found by the Applicant that component d) of the invention is used in polymerization without the need to use buffer agents such as, for example, alkali metal or alkaline-earth metal phosphates or carbonates, producing dispersion characterised by very low grit level.

This represents an advantage since it has been found that the polymer film of the invention shows better water-resistance when applied to textiles.

The examples which follow are given for illustrative purposes, but are not intended to limit the scope of the invention.

### EXAMPLES

Characterization

The tests carried out on the polymer films are:

1) Determination of the maximum tensile strength and the elongation at break according to DIN standard 53455, using a type 4 test sample and a traction speed of 300 mm/min, both in the dry state and after swelling the test samples in water for 24 hours and in ethanol for 8 hours.

2) Determination of the elasticity under a static load, according to ASTM standard D412. Type 5 test samples, according to DIN standard 53455, stretched to 300% (Iₐ) relative to their initial length (Iᵢ), were maintained under tension for a period of 8 hours. They were then positioned vertically and left at rest for a period of 16 hours so as to regain their initial dimensions. At the end, the final length (I_{f}) of the test sample was measured. The elasticity E was calculated in the following way:

E=(Iₐ−I_{f})/(Iₐ−Iᵢ)×100

3) Determination of the Shore A hardness according to ASTM standard D2240-81.

Tests Carried out on Nonwoven Samples Impregnated with the Polymer Dispersions

Preparation of the Test Samples

Samples of nonwovens composed of a mixture of cellulose and polyester fibres are impregnated with the aqueous dispersions of the invention to a weight per unit area of about 50 g/m². After drying the sample (1.5 minutes at 105° C.) and crosslinking for 5 minutes at 130° C., test samples of 5×15 cm in size are obtained.

The test to which samples are subjected is that of traction at a speed of about 2.5 cm/min, by means of which the breaking force and the elongation at break are determined.

The mechanical characteristics are determined on test samples immediately after impregnation, after three washing cycles in water at 60° C., after dry-cleaning, or in wet form after swelling in water for 24 hours and in isopropanol for 8 hours. Table 2 gives the said characteristics.

### Example 1 (Comparative)

Production of an Aqueous Dispersion of a Polymer Not Containing Components c), d) or e) and Containing NMA

1 818 g of deionized water and 16.8 g of nonylphenol ethoxylated with 40 mol of ethylene oxide are added to a glass reactor fitted with a condenser, a stirrer, a temperature control system and inlets for nitrogen, the initiator solutions and the pre-emulsion feed, respectively. An emulsion composed of 1 532 g of deionized water, 161 g of nonylphenol ethoxylated with 40 mol of ethylene oxide, 8.8 g of sodium lauryl sulphate, 2 888 g of n-butyl acrylate (component a), 464 g of acrylonitrile (component b), 38 g of acrylamide (component b) and 54 g of N-methylolacrylamide is prepared in another container fitted with a stirrer (pre-emulsifier). When the content of the reactor has reached a temperature of 50° C., 205 g of the pre-emulsion of monomers prepared above and, successively, 0.25 g of sodium persulphate dissolved in 5 g of deionized water, 16 mg of ferrous sulphate dissolved in 5 g of deionized water and 0.12 g of sodium metabisulphite dissolved in 5 g of deionized water are transferred therein.

Once initiation has been achieved, the temperature inside the reactor rises by about 10° C. (exothermic peak). About one minute after reaching the maximum temperature, the remaining portion of the monomer emulsion and 82 g of sodium metabisulphite at 10% in deionized water and 207 g of sodium persulphate at 5% in deionized water are added to the reactor at a constant feed rate, over a period of 3 hours, taking care to keep the content of the reactor at a temperature of 60° C. throughout the introduction. At the end of the introduction, the reaction mass is maintained at 60° C. for a further 30 minutes and 9.5 g of tert-butyl hydroperoxide dissolved in 63.7 g of deionized water and 7.3 g of sodium formaldehyde sulphoxylate dissolved in 174 g of water are added at a constant feed rate, over a period of 75 minutes. Half an hour after the end of the above addition, the product obtained is cooled to 35° C. and neutralized to a pH between 5 and 6 with 28 Bé aqueous ammonia and 220 g of deionized water, with continued cooling down to room temperature. At the end, the mixture is filtered through a 36 mesh screen.

The dispersion obtained has a pH of 5.2, a viscosity (Brookfield RVT at 100 rpm and at 23° C.) of 100 mPa.s, a dry residue of 46.5% by weight (1 h at 105° C.) and a coagulum content on a 275 mesh screen less than 200 ppm.

### Example 2

1 818 g of deionized water and 16.8 g of nonylphenol ethoxylated with 40 mol of ethylene oxide are added to a glass reactor fitted with a condenser, a stirrer, a temperature control system and inlets for nitrogen, the initiator solutions and the pre-emulsion feed, respectively. An emulsion composed of 1 532 g of deionized water, 161 g of nonylphenol ethoxylated with 40 mol of ethylene oxide, 8.8 g of sodium lauryl sulphate, 2 888 g of n-butyl acrylate (component a), 464 g of acrylonitrile (component b), 38 g of acrylamide (component b), 16.9 g of acrylic acid (component e) and 19.5 g of trimethylolpropane triacrylate (component c) is prepared in another container fitted with a stirrer (pre-emulsifier).

When the content of the reactor has reached a temperature of 50° C., 205 g of the pre-emulsion of monomers prepared above and, successively, 0.25 g of ammonium persulphate dissolved in 5 g of deionized water, 16 mg of ferrous sulphate dissolved in 5 g of deionized water and 0.12 g of sodium metabisulphite dissolved in 5 g of deionized water are transferred therein.

Once initiation has been achieved, the temperature inside the reactor rises by about 10° C. (exothermic peak). About one minute after reaching the maximum temperature, the remaining portion of the monomer emulsion and 82 g of sodium metabisulphite at 10% in deionized water and 207 g of ammonium persulphate at 5% in deionized water are added to the reactor at a constant feed rate, over a period of 3 hours, taking care to keep the content of the reactor at a temperature of 60° C. throughout the introduction. 112 minutes after the start of the introduction, 36 g of vinyltriisopropoxysilane (component d) and 40 g of water are added to the remaining portion of pre-emulsion.

At the end of the introduction, the reaction mass is maintained at 60° C. for a further 30 minutes and 9.5 g of tert-butyl hydroperoxide dissolved in 63.7 g of deionized water and 17.5 g of Bruggolite FF6 (sulphinic acid derivative), sold by Brüggemann, dissolved in 312 g of deionized water are added at a constant feed rate, over a period of 75 minutes.

Half an hour after the end of the above addition, the product obtained is cooled to 35° C. and neutralized to a pH between 5 and 6 with 28 Bé aqueous ammonia and 220 g of deionized water, with continued cooling down to room temperature. At the end, the mixture is filtered through a 36 mesh screen.

The dispersion obtained has a pH of 5.5, a viscosity (Brookfield RVT at 100 rpm and at 23° C.) of 110 mPa.s, a dry residue of 46.0% by weight (1 h at 105° C.) and a coagulum content on a 275 mesh screen less than 200 ppm.

### Example 3 (Comparative)

Production-of an Aqueous Dispersion of a Polymer in which the Vinylsilane Component d) is Replaced with an Acrylsilane

The polymerization of Example 2 is repeated, replacing the vinyltriisopropoxysilane with 38.5 g of γ-methacryloyloxypropyltrimethoxysilane.

The dispersion obtained has a pH of 5.5, a viscosity (Brookfield RVT at 100 rpm and at 23° C.) of 112 mPa.s, a dry residue of 46.1% (1 h at 105° C.) and a coagulum content on a 275 mesh screen of 250 ppm.

### Example 4

The process is performed as in Example 2, replacing the vinyltriisopropoxysilane with 34.8 g of vinyltrimethoxysilane.

The dispersion obtained has a pH of 5.5, a viscosity (Brookfield RVT at 100 rpm and at 23° C.) of 115 mPa.s, a dry residue of 46.0% by weight (1 h at 105° C.) and a coagulum content on a 275 mesh screen lower than 200 ppm.

### Example 5 (Comparative)

The process is performed as in Example 2, without adding the acrylic acid component e) to the pre-emulsion.

The dispersion obtained has a pH of 5.6, a viscosity (Brookfield RVT at 100 rpm and 23° C.) of 130 mPa.s, a dry residue of 45.8% by weight (1 h at 105° C.) and a coagulum content on a 275 mesh screen lower than 200 ppm.

### Example 6

1 818 g of deionized water and 16.8 g of nonylphenol ethoxylated with 40 mol of ethylene oxide are added to a glass reactor fitted with a condenser, a stirrer, a temperature control system and inlets for nitrogen, the initiator solutions and the pre-emulsion feed, respectively. An emulsion composed of 1 532 g of deionized water, 161 g of nonylphenol ethoxylated with 40 mol of ethylene oxide, 8.8 g of sodium lauryl sulphate, 2 888 g of n-butyl acrylate (component a), 464 g of acrylonitrile (component b), 38 g of acrylamide (component b), 18 g of maleic anhydride (component e) and 19.5 g of trimethylolpropane triacrylate (component c) is prepared in another container fitted with a stirrer (pre-emulsifier).

When the content of the reactor has reached a temperature of 50° C., 205 g of the pre-emulsion of monomers prepared above and, successively, 0.25 g of ammonium persulphate dissolved in 5 g of deionized water, 16 mg of ferrous sulphate dissolved in 5 g of deionized water and 0.12 g of sodium metabisulphite dissolved in 5 g of deionized water are transferred therein.

Once initiation has been achieved, the temperature inside the reactor rises by about 10° C. (exothermic peak). About one minute after reaching the maximum temperature, the remaining portion of the monomer emulsion and 82 g of sodium metabisulphite at 10% in deionized water and 207 g of ammonium persulphate at 5% in deionized water are added to the reactor at a constant feed rate, over a period of 3 hours, taking care to keep the content of the reactor at a temperature of 60° C. throughout the introduction. 112 minutes after the start of the introduction, 36 g of vinyltriisopropoxysilane (component d), 18 g of maleic anhydride (component e) and 40 g of water are added to the remaining portion of pre-emulsion.

At the end of the introduction, the reaction mass is maintained at 60° C. for a further 30 minutes and 9.5 g of tert-butyl hydroperoxide dissolved in 63.7 g of deionized water and 17.5 g of Bruggolite FF6 (sulphinic acid derivative), sold by Brüggemann, dissolved in 312 g of deionized water are added at a constant feed rate, over a period of 75 minutes.

Half an hour after the end of the above addition, the product obtained is cooled to 35° C. and neutralized to a pH between 5 and 6 with 28 Bé aqueous ammonia and 220 g of deionized water, with continued cooling down to room temperature. At the end, the mixture is filtered through a 36 mesh screen.

The dispersion obtained has a pH of 5.5, a viscosity (Brookfield RVT at 100 rpm and at 23° C.) of 190 mPa.s, a dry residue of 46.2% by weight (1 h at 105° C.) and a coagulum content on a 275 mesh screen lower than 220 ppm.

### Example 7

Application of the Aqueous Dispersions Obtained in the above Examples to the Process of Impregnation of Nonwovens

The mechanical characteristics determined as mentioned above are given in the tables.

Table 1 shows the mechanical characteristics of the polymer films pretreated for 5 minutes at 160° C., under dry conditions and after swelling in water for 24 hours and in ethanol for 8 hours.

Table 2 compares the mechanical characteristics defined above obtained before and after the heat treatment for 5 at 160° C.

Table 3 shows the mechanical characteristics of the nonwovens under dry and wet conditions and after washing as indicated above.

From the results of Table 1, it may be seen that the acrylic dispersions of the invention show good mechanical properties like those functionalized with N-methylolacrylamide, but without release of formaldehyde.

The data in Table 2 demonstrate that the presence of the acid (component e)) makes it possible to obtain improved mechanical properties both before and after heat treatment for 5 minutes at 160° C.

The data in Table 3 show that the mechanical properties of the nonwovens impregnated with the dispersions of the invention are comparable with those functionalized with N-methylolacrylamide, but without release of formaldehyde.

TABLE 1

| | | | Test sample after | | Test sample after | | | |
|---|---|---|---|---|---|---|---|---|
| | | | swelling in water | | swelling in ethanol | | | |
| | Dry test sample | | for 24 hours | | for 8 hours | | Dry test sample | |
| | Elongation | Maximum | Elongation | Maximum | Elongation | Maximum | Elasti- | |
| | at break | load | at break | load | at break | load | city | Shore A |
| Ex. | (%) | (N/mm²) | (%) | (N/mm²) | (%) | (N/mm²) | (%) | hardness |
| 1 compar. | 1050 | 1.1 | 900 | 0.5 | 665 | 0.18 | 88 | 13 |
| 2 | 1200 | 1.9 | 1150 | 1.0 | 580 | 0.21 | 90 | 12 |
| 3 compar. | 380 | 2.0 | 245 | 0.9 | 42 | 0.05 | n.d. | 16 |
| 4 | 780 | 2.1 | 800 | 1.9 | 490 | 0.21 | 97 | 14 |
| 5 compar. | 1500 | 0.9 | 1450 | 0.9 | 646 | 0.17 | 75 | 15 |
| 6 | 900 | 1.6 | 790 | 1.2 | 550 | 0.26 | 95 | 14 |

n.d. = not determinable

TABLE 2

| | Dry test sample | | | |
|---|---|---|---|---|
| | without heat | | | |
| | treatment | | Dry test sample after | |
| | (160° C., 3 min.) | | heat treatment | |
| | Elongation | Maximum | Elongation | Maximum |
| at break | load | at break | load | |
| Ex. | (%) | (N/mm²) | (%) | (N/mm₂) |
| 2 | 1300 | 1.6 | 1200 | 1.9 |
| 5 compar. | 1600 | 0.8 | 1500 | 0.9 |
| 6 | 1050 | 1.4 | 900 | 1.6 |

TABLE 3

| | | | | Wet resistance | |
|---|---|---|---|---|---|
| Dry resistance | | | | | Test |
| | | | Test | Test | sample |
| | Untreated | Test sample | sample | sample | soaked in |
| | test | after washing | after dry- | soaked in | isopropyl |
| Ex. | sample | in water | cleaning | water | alcohol |
| 1 | | | | | |
| compar. | | | | | |
| (A) | 40 | 41 | 26 | 17 | 13 |
| (B) | 1750 | 1730 | 1155 | 700 | 545 |
| 2 | | | | | |
| (A) | 40 | 38 | 25 | 15 | 15 |
| (B) | 1705 | 1665 | 1100 | 650 | 550 |

(A) = breaking force F measured in N.
(B) = elongation at break L expressed in metres, calculated by the following formula
L = F 10⁶/l.g.9.81
where 1 = width of the test sample expressed in mm, g is the weight per unit area expressed in g/m² and 9.81 is the acceleration due to gravity.

1. Aqueous dispersions of acrylic polymers which do not release formaldehyde during the application of the dispersions, comprising the following components:
a) from 25% to 95% by weight of one or more polymerizable acrylic monomers whose corresponding homopolymer has a glass transition temperature (Tg) less than 0° C. and preferably less than −20° C.;
b) from 4% to 70% by weight of one or more polymerizable acrylic monomers whose corresponding homopolymer has a Tg greater than 0° C. and preferably greater than 40° C.;
c) from 0.05% to 4% by weight and preferably from 0.05% to 2% by weight of one or more monomers containing at least two ethylenic unsaturations;
d) from 0.2% to 5% and preferably 0.5-3% by weight of a vinylsilane having the formula:
CH₂═CR—Si(OR′)ₙRₘ
in which:
n is an integer equal to 2 or 3;
m is an integer equal to 0 or 1,
R=H or CH₃,
R′=C₁-C₁₀ and preferably C₃-C₅ alkyl group, which is linear or branched if possible;
e) from 0.2% to 10% by weight of an ethylenically unsaturated monomer containing one or more acid groups, preferably carboxylic acid groups, or corresponding salts and/or corresponding anhydrides;
the sum of the components a) +b) +c) +d) +e) being 100%, the said aqueous dispersions being obtainable by means of a free-radical polymerization process, the polymerization being carried out in the presence of initiator systems or redox pairs in which the reducing agent does not release formaldehyde, the polymer dispersion at the end of the polymerization being subjected to a treatment to reduce the free monomer content with redox pairs in which the reducing agent does not release formaldehyde.

2. Dispersions according to claim 1, in which the initiator systems used in the polymerization phase (pre-emulsion feed) are those for the free-radical polymerization of monomers in aqueous emulsion, preferably organic hydroperoxides in aqueous solution or salts thereof and peroxydisulphuric acid salts.

3. Dispersions according to claims 1-2, in which the reducing agents of the redox pairs which do not release formaldehyde are ammonium or alkali metal sulphites and hydrogen sulphites; ascorbic acid; a monofunctional aldehyde with a number of carbon atoms greater than or equal to 4 and containing at least one salifiable hydrogen, which is organic or inorganic, or salts thereof, the aldehyde reducing agent or salts thereof being water-soluble to at least 5% by weight and preferably to at least 10% by weight; a sulphinic acid of formula MO—S(O)—C(R¹R²R³), in which M is hydrogen, ammonium, a monovalent metal ion or a divalent ion chosen from groups Ia, IIa, IIb, IVa and VIIIb; R¹ is OH or NR⁴R⁵ in which R⁴ and R⁵, independently of each other, are H or C₁-C₆ alkyl; R² is H, alkyl, alkenyl, cycloalkyl or aryl, in which the aromatic ring is optionally substituted in position 1, 2 or 3, which are chosen, independently of each other, from C₁-C₆ alkyl, OH, C₁-C₆ alkoxy, halogen, CF₃; R³ is H, COOM, SO₃M, COR⁴, CONR⁴R⁵ or COOR⁴, in which M, R⁴ and R⁵ have the meanings given above or, when R² is aryl, it is as defined above.

4. Dispersions according to claims 1-3, in which the components d) and optionally e) are added after the components a) +b) +c) have been polymerized, preferably to about one-half by weight of the total amount of the monomers, the amount of e), when it is present together with a) +b) +c), ranging from 0% to 100% by weight of e).

5. Dispersions according to claim 4, in which the components d) and optionally e) are added after the components a) +b) +c) have been polymerized, preferably to about two thirds by weight relative to the total weight of the monomers.

6. Dispersions according to claims 1-3, in which the component e) is polymerized in the first pre-emulsion together with a) +b) +c), preferably to at least one-half by weight relative to the total amount of the monomers, the amount of e) being between 0% and 75% by weight relative to the total amount of e), followed by the addition of a second pre-emulsion a) +b) +d) +e) in which the amount of e) is between 25% and 100% by weight relative to the total amount of e).

7. Dispersions according to claims 1-6, in which monomers of (meth)acrylic type containing from 4 to 20 carbon atoms and preferably from 5 to 15 carbon atoms are used as component a).

8. Dispersions according to claims 1-7, in which monomers of (meth)acrylic type containing from 3 to 20 carbon atoms and preferably from 3 to 10 carbon atoms are used as component b).

9. Dispersions according to claim 8, in which the component b) is mixed with styrene or derivatives thereof in an amount of from 5% to 70% by weight relative to the total weight of b).

10. Dispersions according to claims 1-9, in which monomers containing at least two ethylenic unsaturations of acrylic, vinylic or allylic type, preferably monomers containing more than two of the said unsaturations, are used as component c).

11. Dispersions according to claims 1-10, in which the component d) is chosen from vinyltriisopropoxysilane and vinyltrimethoxysilane.

12. Dispersions according to claims 1-11, in which the component e) is chosen from (meth)acrylic acid, itaconic acid, acrylamidodimethylpropanesulphonic acid, styrenesulphonic acid, maleic acid and fumaric acid, or the anhydrides or salts of the said acids.

13. Dispersions according to claims 1-12, containing from 60% to 90% by weight of component a), from 5% to 30% by weight of component b), from 0.5% to 1.5% by weight of component c), from 0.5% to 4% by weight of component d) and from 0.5% to 2.5% by weight of component e), the sum of the components being 100%.

14. Use of the dispersions according to claims 1-13 for treating glass fibres and textile fibres, optionally in the form of wovens or nonwovens.

15. Glass fibres and textile fibres, optionally in the form of wovens or nonwovens according to claim 14.
